(19) United States
(12) Patent Application Publication
(10) Pub. No.: US 2026/0303968 A1
(43) Pub. Date: Oct. 1, 2026

(54) IMAGE PROCESSING DEVICE AND METHOD FOR PROCESSING IMAGE SIGNAL

(71) Applicant: SK hynix Inc., Icheon-si (KR)

(72) Inventor: Kazuhiro YAHATA, Tokyo (JP)

(21) Appl. No.: 19/633,547

(22) Filed: Mar. 30, 2026

(30) Foreign Application Priority Data
Mar. 28, 2025 (KR) 10-2025-0040543

(51) Int. Cl. H04N 23/67; H04N 25/61; H04N 25/618; H04N 25/704

(52) U.S. Cl. CPC H04N 23/672; H04N 25/61; H04N 25/618; H04N 25/704

(57) ABSTRACT

Image sensing devices, image processing devices, and image signal processing methods are disclosed. In an embodiment, an image processing device includes a reference pixel determinator configured to receive first phase image data including pixel data of a first target pixel and determines, as a first reference pixel for the first target pixel, at least one pixel that is located in a direction perpendicular to a phase difference direction of the first phase image data, with respect to the first target pixel, and a noise reducer configured to perform noise reduction processing on the pixel data of the first target pixel by using pixel data of the first reference pixel.

### CROSS-REFERENCE TO RELATED APPLICATION

This patent document claims the priority and benefits of Korean Patent Application No. 10-2025-0040543, filed on Mar. 28, 2025, the entire contents of which are incorporated herein by reference.

### TECHNICAL FIELD

The technology and implementations disclosed in this patent document generally relate to an image processing device for phase difference detection.

### BACKGROUND

An image sensing device captures an optical image by using the properties of a photosensitive semiconductor material that reacts to light. With the development of automotive, medical, computer and communication industries, the demand for a high-performance image sensing device is increasing in various fields such as a smartphone, a digital camera, a game machine, an IoT (Internet of Things), a robot, a security camera, and a medical micro camera.

An image processing device may have a phase-difference detection autofocus (PDAF) function, which automatically brings an image into focus by using the phase difference of a detected image. For phase difference detection, some pixels included in a pixel array may be replaced with phase difference detection pixels. The pixel array may include pixels arranged in a matrix, up to a preset number.

### SUMMARY

Some embodiments of the disclosed technology can address the above-mentioned issues while optionally retaining certain beneficial features.

An aspect of the disclosed technology provides an image processing device having a phase difference detection autofocus function.

An aspect of the disclosed technology provides an image processing device designed to perform a phase difference detection autofocus function by reducing random noise of a phase difference image.

In an aspect of the disclosed technology, an image processing device may include a reference pixel determinator that receives a first phase image data including pixel data of a first target pixel and determines, as a first reference pixel for the first target pixel, at least one pixel that is located in a direction perpendicular to a phase difference direction of the first phase image data, with respect to the first target pixel, and a noise reducer that performs noise reduction processing on the pixel data of the first target pixel by using pixel data of the first reference pixel.

In an aspect of the disclosed technology, an image processing device may include a reference pixel determinator that receives phase image data including pixel data of a target pixel, sets a plurality of pixel groups, each including the target pixel and at least one pixel located in a direction perpendicular to a phase difference direction of a phase image, with respect to a pixel adjacent to the target pixel, selects one of the plurality of pixel groups, and determines at least one pixel included in the selected pixel group as a reference pixel, and a noise reducer that performs noise reduction processing on the pixel data of the target pixel by using pixel data of the reference pixel.

In an aspect of the disclosed technology, an image signal processing method may include receiving, by an image processing device, a phase difference image in a first direction, determining, by the image processing device, as a reference pixel for the first target pixel, at least one pixel that is located in a second direction perpendicular to the first direction from a target pixel included in the phase difference image, and performing, by the image processing device, noise reduction processing on pixel data of the target pixel by using pixel data of the reference pixel.

### BRIEF DESCRIPTION OF THE DRAWINGS

The above and other features and beneficial aspects of the disclosed technology will become more apparent from the following detailed description taken in conjunction with the accompanying drawings.

FIG. 1 is a block diagram illustrating a configuration of an image sensing device based on an embodiment of the disclosed technology.

FIG. 2 is a block diagram illustrating a configuration of an image processing device based on an embodiment of the disclosed technology.

FIG. 3 is a block diagram illustrating a phase image extractor based on an embodiment of the disclosed technology.

FIG. 4 is a block diagram illustrating a noise processor based on an embodiment of the disclosed technology.

FIG. 5 is a block diagram illustrating a phase difference calculator based on an embodiment of the disclosed technology.

FIG. 6 is a flowchart illustrating an operation of an image processing device based on an embodiment of the disclosed technology.

FIG. 7 is a diagram illustrating a micro lens and a plurality of pixels corresponding thereto, based on an embodiment of the disclosed technology.

FIG. 8 is a diagram illustrating a target kernel and a filter kernel used to perform noise reduction processing on a left-right phase image, based on an embodiment of the disclosed technology.

FIG. 9 is a diagram illustrating a target kernel and a filter kernel used to perform noise reduction processing on an up-down phase image, based on an embodiment of the disclosed technology.

FIG. 10 is a diagram illustrating pixel groups used to perform noise reduction processing on a phase image, based on an embodiment of the disclosed technology.

FIG. 11 is a diagram illustrating a left-right phase image before noise reduction processing and a left-right phase image after noise reduction processing, based on an embodiment of the disclosed technology.

FIG. 12 is a diagram illustrating an up-down phase image before noise reduction processing and an up-down phase image after noise reduction processing, based on an embodiment of the disclosed technology.

FIG. 13 is a block diagram illustrating an example of a computing device corresponding to a processor of FIG. 1.

### DETAILED DESCRIPTION

Various embodiments will be described with reference to the accompanying drawings. However, it should be understood that the disclosed technology is not limited to a specific embodiment described herein and includes various modifications, equivalents, and/or alternatives of an embodiment. Some embodiments of the disclosed technology may provide various effects capable of being directly/indirectly recognized through the following description.

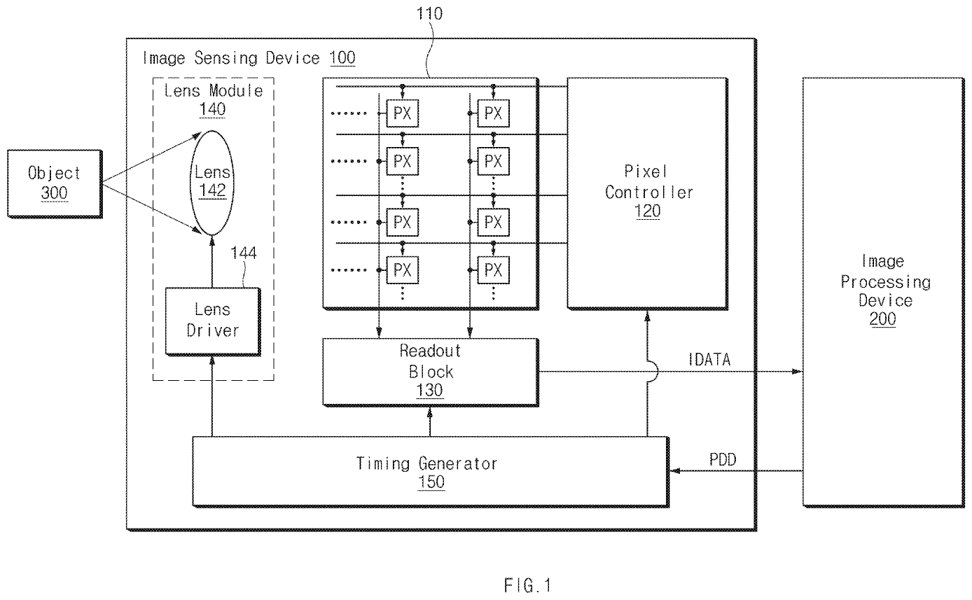

FIG. 1 is a block diagram illustrating a configuration of an image sensing device based on an embodiment of the disclosed technology.

Referring to FIG. 1, an image sensing device 100 may be implemented as a part of an imaging device. The imaging device may refer to a device such as a digital still camera, which captures a still image, or a digital video camera, which captures a video. For example, the imaging device may be implemented with a digital single lens reflex (DSLR), a mirrorless camera, or a smartphone, but the disclosed technology is not limited thereto. For example, the imaging device may refer broadly to a device that includes imaging elements and is capable of capturing a subject and generating an image corresponding to the subject.

In an embodiment, the image sensing device 100 may be a complementary metal oxide semiconductor image sensor (CIS), which converts an incident light into an electrical signal. The image sensing device 100 may include a pixel array 110, a pixel controller 120, a readout block 130, a lens module 140, and a timing generator 150. An image processing device 200 implemented based on some embodiments of the disclosed technology may correspond to an image signal processor (ISP). For example, the image processing device 200 may include the ISP and may perform operations of the disclosed technology by using the ISP. In an implementation, the image processing device 200 is disposed within the image sensing device 100. In another implementation, the image processing device 200 is disposed outside the image sensing device 100.

In an embodiment, the pixel array 110 may include a plurality of pixels PX arranged continuously in a two-dimensional matrix configuration (e.g., arranged continuously in a column direction and/or a row direction). Under the control of the pixel controller 120, each of the plurality of pixels PX may sense an incident light to generate a pixel signal. The pixel signal may represent the number of photo charges generated depending on the intensity of incident light.

In an embodiment, the pixels PX belonging to one row may be supplied with the same pixel control signal from the pixel controller 120. The pixels PX belonging to one column may be connected to one column line to output pixel signals to the readout block 130. In another embodiment, the pixels PX belonging to one column may be independently connected to different column lines to output pixel signals to the readout block 130.

In an embodiment, light emitted or reflected from an object 300 and passes through a lens 142 may be converted into electrical signals by the pixels PX included in the pixel array 110. In an example, the pixels PX may be arranged in the pixel array 110, e.g., in a matrix. The electrical signals generated by the pixels PX may be converted into pixel data through the readout block 130.

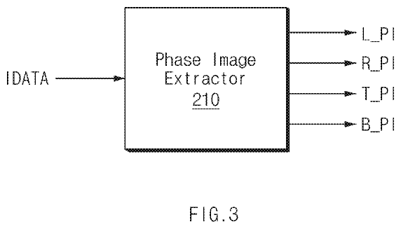

In an example, an image signal generated in response to light emitted or reflected from the object 300 and incident on the pixel array 110 may be used as a signal for generating an image. As an example, the image signal may correspond to the pixel signal. In an example, the pixels PX may be image detection pixels, and a plurality of phase images may be generated based on the image signals generated by the pixels PX. In an example, image signals generated by the pixels PX may be classified based on channel positions of micro lenses, and the plurality of phase images may be generated based on the classified image signals. In an example, a phase difference image may be generated based on the plurality of phase images, and a phase difference may be calculated based on the phase difference image. The plurality of phase images will be described in detail with reference to FIG. 3.

In an embodiment, the pixel array 110 may correspond to a sensor configuration in which a micro lens corresponds to an array of the pixels PX arranged in one or more rows and one or more columns. For example, the pixel array 110 may include a structure where a plurality of pixels PX share one micro lens. In the disclosed technology, it is assumed that the pixel array 110 includes a structure in which a micro lens corresponds to an array of the pixels PX arranged in one or more rows and one or more columns. In an example, in the pixel array 110, a plurality of pixels PX may share one micro lens. In this case, both a color image and a phase difference may be detected from all the pixels PX of the pixel array 110. For example, operations of the image processing device 200 based on some embodiments of the disclosed technology may be performed based on the pixel array 110 in which pixels PX arranged in a 2×2, 2×4, 4×2, 3×3, or 4×4 matrix share one micro lens.

In an embodiment, the pixel controller 120 may drive the pixels PX in response to a timing signal output from the timing generator 150. For example, the pixel controller 120 may generate a control signal that can be used to select and control pixels PX included in at least one row line among a plurality of row lines of the pixel array 110.

In an embodiment, under the control of the timing generator 150, the readout block 130 may sense or detect pixel signals output from the pixel array 110 and may output the sensed pixel signals as pixel data. In an example, pixel data respectively output from the pixels PX may be collected to constitute image data IDATA. In some implementations, the readout block 130 may include a sense amplifier that amplifies and outputs a voltage level of each bit of the pixel signal, a memory that temporarily stores pixel data output from the sense amplifier, and/or an output interface that outputs the pixel data to an external device (e.g., an image signal processor) under control of the timing generator 150.

In an embodiment, the lens module 140 may be a component that receives light. In an example, the lens module 140 may include the lens 142 and a lens driver 144. In an example, the lens 142 may refer to a component that includes a plurality of lenses as well as a single lens. As a position of the lens 142 is adjusted, the focus on the object 300 may be changed. The position of the lens 142 may be adjusted by the lens driver 144, based on signals generated from the pixels PX.

In an embodiment, the lens driver 144 may control the position of the lens 142 depending on the control signal (e.g., phase difference data PDD) of the image processing device 200. In an example, the timing generator 150 may receive the phase difference data PDD from the image processing device 200 and may transfer a control signal (not illustrated) to the lens driver 144 based on the received phase difference data PDD. In some implementations, the lens driver 144 may adjust a distance between the lens 142 and the object 300. In an example, the lens driver 144 may transfer data (not illustrated) corresponding to a distance between the pixel array 110 and the lens 142 to the image processing device 200.

In an embodiment, the timing generator 150 may generate the timing signal for controlling operations of the pixel controller 120, the readout block 130, and the lens driver 144. In an embodiment, the timing generator 150 may generate the timing signal based on a request of the image processing device 200. In an embodiment, the timing generator 150 may include a logic control circuit, a phase locked loop (PLL) circuit, a timing control circuit, a communication interface circuit, etc.

In an embodiment, the image processing device 200 may receive the image data IDATA from the readout block 130 of the image sensing device 100. Also, the image processing device 200 may generate the phase difference data PDD based on the image data IDATA and may transfer the phase difference data PDD to the timing generator 150. In an example, the image processing device 200 may generate processed image data by performing at least one image signal processing on the image data IDATA. The image processing device 200 may reduce the noise of the image data IDATA and may perform image signal processing for improving the quality of image, such as demosaicing, defect pixel correction, gamma correction, color filter array interpolation, color matrix, color correction, color enhancement, or lens distortion correction. Also, the image processing device 200 may generate an image file by performing compression processing on image data experiencing the image signal processing for improving the quality of image or may recover the image data from the image file. A compression format of an image may be a reversible format or an irreversible format. As an example of the compression format, the JPEG (Joint Photographic Experts Group) format or the JPEG 2000 format may be used for a still image. Also, in the case of a moving image, a moving image file may be generated by compressing a plurality of frames in compliance with the MPEG (Moving Picture Experts Group) standard.

In an embodiment, the image data IDATA may be generated by the image sensing device 100, which captures an optical image of a scene, but the scope of the disclosed technology is not limited thereto. In the disclosed technology, the description will be given under the assumption that the image data IDATA are generated by the image sensing device 100.

In an embodiment, the image processing device 200 may provide the lens driver 144 with information about focus detection based on the image signal. For example, the image processing device 200 may transfer the phase difference data PDD to the timing generator 150, and the timing generator 150 may transfer the control signal to the lens driver 144 based on the phase difference data PDD. In an example, when the phase difference is absent from the signals generated from the pixels PX, the distance between the lens 142 and the object 300 may be an in-focus position. In an example, when the distance between the lens 142 and the object 300 is not the in-focus position, a difference may occur between signals generated from the pixels PX. In an example, based on the control signal provided from the timing generator 150, the lens driver 144 may move the lens 142 such that the distance between the lens 142 and the object 300 is the in-focus position.

In an embodiment, the image processing device 200 may obtain phase information, image information, etc. based on the image data IDATA output from the image sensing device 100. In an example, the image processing device 200 may control the operation of the image sensing device 100. For example, the image processing device 200 may provide a control signal (e.g., PDD) for each component (e.g., the timing generator 150) of the image sensing device 100 based on the image data IDATA received from the image sensing device 100.

In an embodiment, the image processing device 200 may receive a phase signal from the image sensing device 100 to perform phase difference calculation. For example, the image processing device 200 may perform phase difference calculation based on the phase information obtained from any two pixels among the pixels PX arranged in the 2×2 matrix. In an example, the image processing device 200 may obtain a position of the focus, a direction, a distance between the object 300 and the image sensing device 100, etc. through the phase difference calculation. In an example, the image processing device 200 may transfer the phase difference data PDD for controlling the lens driver 144 to the timing generator 150 based on a phase difference calculation result.

In an embodiment, the image processing device 200 may perform image signal processing for improving the quality of image, such as noise correction and interpolation between adjacent pixels, in addition to the above operation.

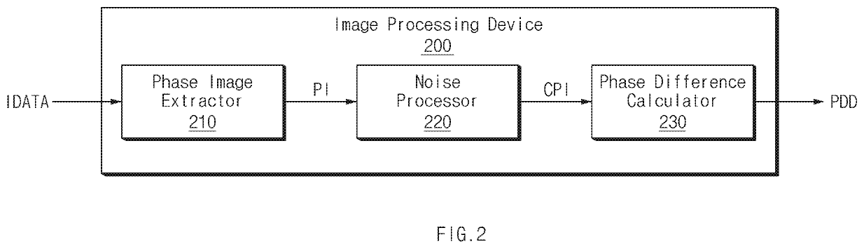

FIG. 2 is a block diagram illustrating a configuration of an image processing device based on an embodiment of the disclosed technology.

Referring to FIG. 2, the image processing device 200 may include a phase image extractor 210, a noise processor 220, and a phase difference calculator 230. In an example, the image processing device 200 may receive the image data IDATA from the image sensing device 100. In an example, the image processing device 200 may generate the phase difference data PDD based on operations of the phase image extractor 210, the noise processor 220, and the phase difference calculator 230 described above. The configuration of the image processing device 200 based on some embodiments of the disclosed technology is provided by way of example only. For example, the image processing device 200 may further include additional components, or some of the illustrated components of the image processing device 200 may be omitted. For example, the phase image extractor 210 and/or the phase difference calculator 230 may be omitted. For example, the phase image extractor 210 and/or the phase difference calculator 230 may be included in a device (e.g., an application processor) located outside the image processing device 200.

In an embodiment, the phase image extractor 210 may extract phase image PI, based on the image data IDATA. In an example, the phase image PI may correspond to one or more directions. For example, the phase image extractor 210 may extract the phase image PI corresponding to a left-right direction or an up-down direction, based on the image data IDATA. The phase image extractor 210 may transfer the extracted phase image PI to the noise processor 220. In an example, the phase image extractor 210 may classify pixels for each channel and may extract the phase image PI based on pixel data of the pixels classified for each channel. The operation of the phase image extractor 210 will be described in detail with reference to FIG. 3. In some embodiments, the terms “left-right direction” and “up-down direction” are defined based on the arrangement of pixels under a micro lens. Specifically, the left-right direction corresponds to the horizontal axis across the pixels, and the up-down direction corresponds to the vertical axis across the pixels.

In an embodiment, the noise processor 220 may receive one or more phase images PI from the phase image extractor 210. In an example, the noise processor 220 may perform noise reduction processing on the received phase image PI and may transfer noise reduction-processed phase image (hereinafter referred to as “corrected phase image”) CPI to the phase difference calculator 230 as a result of the reduction processing.

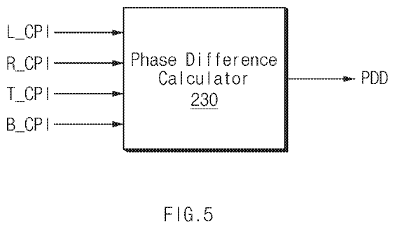

In an embodiment, the phase difference calculator 230 may receive the corrected phase image CPI from the noise processor 220. In an example, the phase difference calculator 230 may calculate a phase difference based on the corrected phase image CPI and may generate the phase difference data PDD based on the calculated phase difference. In an example, the phase difference calculator 230 may transfer the generated phase difference data PDD to a timing generator (e.g., 150) or a lens driver (e.g., 144), and the lens driver (e.g., 144) may adjust the position of the lens 142 based on the received phase difference data PDD. The operation of the phase difference calculator 230 will be described in detail with reference to FIG. 5.

FIG. 3 is a block diagram illustrating a phase image extractor based on an embodiment of the disclosed technology.

Referring to FIG. 3, the phase image extractor 210 may extract images having different phases from the image data IDATA. For example, the phase image extractor 210 may generate at least one of left phase image L_PI corresponding to a left phase, right phase image R_PI corresponding to a right phase, top phase image T_PI corresponding to a top phase, and bottom phase image B_PI corresponding to a bottom phase, based on the image data IDATA received from the image sensing device 100.

In an example, a pixel array (e.g., 110) may be configured such that a plurality of pixels shares one micro lens. In an example, the plurality of pixels corresponding to the micro lens may be classified for each channel. The channel may correspond to a position of a pixel located in a specific direction with respect to the center of the micro lens. For example, a first channel may be located on the upper left-side of the micro lens, a second channel may be located on the upper right-side of the micro lens, a third channel may be located on the lower left-side of the micro lens, and a fourth channel may be located on the lower right-side of the micro lens.

In an embodiment, the phase image extractor 210 may classify pixels by channel and may extract at least phase image based on pixel data of the pixels classified for each channel. For example, a pixel corresponding to the upper left-side of the micro lens may belong to the first channel, a pixel corresponding to the upper right-side of the micro lens may belong to the second channel, a pixel corresponding to the lower left-side of the micro lens may belong to the third channel, and a pixel corresponding to the lower right-side of the micro lens may belong to the fourth channel. The phase image extractor 210 may extract a phase image by identifying pixel data of the pixels from the first to fourth channels.

In an embodiment, the phase image extractor 210 may provide the noise processor 220 with the left phase image L_PI, the right phase image R_PI, the top phase image T_PI, and the bottom phase image B_PI extracted by the phase image extractor 210. For example, the phase image extractor 210 may extract the left phase image L_PI based on pixel data of the pixels respectively belonging to the first and third channels of the micro lens and may extract the right phase image R_PI based on pixel data of the pixels respectively belonging to the second and fourth channels of the micro lens. For example, the phase image extractor 210 may extract the top phase image T_PI based on pixel data of the pixels respectively belonging to the first and second channels of the micro lens and may extract the bottom phase image B_PI based on pixel data of the pixels respectively belonging to the third and fourth channels of the micro lens.

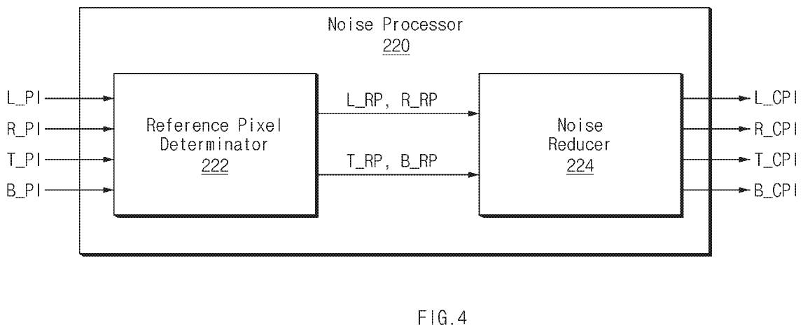

FIG. 4 is a block diagram illustrating a noise processor based on an embodiment of the disclosed technology.

Referring to FIG. 4, the noise processor 220 may include a reference pixel determinator 222 and a noise reducer 224. In an example, the noise processor 220 may receive the left phase image L_PI, the right phase image R_PI, the top phase image T_PI, and the bottom phase image B_PI from the phase image extractor 210 and may generate and output corrected left phase image L_CPI, corrected right phase image R_CPI, corrected top phase image T_CPI, and corrected bottom phase image B_CPI based on the left phase image L_PI, the right phase image R_PI, the top phase image T_PI, and the bottom phase image B_PI thus received.

In an embodiment, the noise processor 220 may perform noise reduction processing on the received phase image (e.g., L_PI, R_PI, T_PI, or B_PI) to generate corrected phase image (e.g., L_CPI, R_CPI, T_CPI, or B_CPI). For example, the noise processor 220 may perform noise reduction processing on the left phase image L_PI, the right phase image R_PI, the top phase image T_PI, and the bottom phase image B_PI and may transfer the corrected left phase image L_CPI, the corrected right phase image R_CPI, the corrected top phase image T_CPI, and the corrected bottom phase image B_CPI to the phase difference calculator 230.

In an embodiment, the reference pixel determinator 222 may receive a phase image (e.g., L_PI, R_PI, T_PI, or B_PI) from the phase image extractor 210. In an example, the reference pixel determinator 222 may receive the left phase image L_PI, the right phase image R_PI, the top phase image T_PI, and the bottom phase image B_PI for calculating a phase difference, from the phase image extractor 210. A phase difference direction based on some embodiments of the disclosed technology may include the left-right direction or the up-down direction. For example, the phase difference direction of the left phase image L_PI or the right phase image R_PI may correspond to the left-right direction. For example, the phase difference direction of the top phase image T_PI or the bottom phase image B_PI may correspond to the up-down direction.

In an embodiment, to calculate the phase difference in the left-right direction, the reference pixel determinator 222 may receive the left phase image L_PI and/or the right phase image R_PI. In an example, the left-right direction may correspond to the first direction. In an example, the reference pixel determinator 222 may identify a reference pixel L_RP for the received left phase image L_PI or a reference pixel R_RP for the received right phase image R_PI so as to be transferred to the noise reducer 224. For example, the reference pixel determinator 222 may determine the reference pixel L_RP for performing noise reduction processing on target pixel data of the left phase image L_PI. For example, the reference pixel determinator 222 may determine the reference pixel R_RP for performing noise reduction processing on target pixel data of the right phase image R_PI. In an example, the left phase image L_PI or the right phase image R_PI identified by the reference pixel determinator 222 may be used to generate a phase difference image of the left-right direction.

In an embodiment, to calculate the phase difference in the up-down direction, the reference pixel determinator 222 may receive the top phase image T_PI and/or the bottom phase image B_PI. In an example, the up-down direction may correspond to the second direction. In an example, the reference pixel determinator 222 may identify a reference pixel T_RP for the received top phase image T_PI or a reference pixel B_RP for the received bottom phase image B_PI as to be transferred to the noise reducer 224. For example, the reference pixel determinator 222 may determine the reference pixel T_RP for performing noise reduction processing on target pixel data of the top phase image T_PI. For example, the reference pixel determinator 222 may determine the reference pixel B_RP for performing noise reduction processing on target pixel data of the bottom phase image B_PI. In an example, the top phase image T_PI or the bottom phase image B_PI identified by the reference pixel determinator 222 may be used to generate a phase difference image of the up-down direction.

In an embodiment, the reference pixel determinator 222 may identify at least one reference pixel for performing noise reduction processing on a target pixel corresponding to a phase image (e.g., L_PI, R_PI, T_PI, or B_PI) received from the phase image extractor 210, based on the phase difference direction of the phase image (e.g., L_PI, R_PI, T_PI, or B_PI) thus received.

In an embodiment, the reference pixel determinator 222 may identify at least one pixel located in a direction perpendicular to the phase difference direction with respect to the target pixel of the phase image (e.g., L_PI, R_PI, T_PI, or B_PI) received from the phase image extractor 210 and may determine the identified pixel as a reference pixel. For example, when the phase image received from the phase image extractor 210 is the left phase image L_PI or the right phase image R_PI, the reference pixel determinator 222 may determine, as a reference pixel, at least one pixel located in the up-down direction from the target pixel included in the left phase image L_PI or the right phase image R_PI or at least one pixel located in the up-down direction from a pixel adjacent to the target pixel. For example, when the phase image received from the phase image extractor 210 is the top phase image T_PI or the bottom phase image B_PI, the reference pixel determinator 222 may determine, as a reference pixel, at least one pixel located in the left-right direction from the target pixel included in the top phase image T_PI or the bottom phase image B_PI or at least one pixel located in the left-right direction from a pixel adjacent to the target pixel.

In an embodiment, the reference pixel determinator 222 may identify the target pixel and/or the reference pixel included in the phase image (e.g., L_PI, R_PI, T_PI, or B_PI) and may transfer identification information (e.g., L_RP, R_RP, T_RP, and/or B_RP) of the target pixel and/or the reference pixel to the noise reducer 224. In an example, the identification information (e.g., L_RP, R_RP, T_RP, and/or B_RP) of the target pixel and/or the reference pixel may include coordinates on the pixel array 110, a channel position, and/or pixel data, which are associated with the target pixel and/or the reference pixel. In an example, the reference pixel determinator 222 may classify the identification information (e.g., L_RP, R_RP, T_RP, and/or B_RP) of the target pixel and/or the reference pixel depending on the phase difference direction of the phase image, so as to be transferred to the noise reducer 224. For example, the reference pixel determinator 222 may transfer the identification information (e.g., L_RP) of the target pixel and/or the reference pixel included in the left phase image L_PI and the identification information (e.g., R_RP) of the target pixel and/or the reference pixel included in the right phase image R_PI to the noise reducer 224. For example, the reference pixel determinator 222 may transfer the identification information (e.g., T_RP) of the target pixel and/or the reference pixel included in the top phase image T_PI and the identification information (e.g., B_RP) of the target pixel and/or the reference pixel included in the bottom phase image B_PI to the noise reducer 224.

In an embodiment, when the reference pixel determinator 222 receive first phase image data (e.g., L_PI or R_PI) including pixel data of a first target pixel from the phase image extractor 210, the reference pixel determinator 222 may identify the first reference pixel, and when the reference pixel determinator 222 receive second phase image data (e.g., T_PI or B_PI) including pixel data of a second target pixel from the phase image extractor 210, the reference pixel determinator 222 may identify the second reference pixel. For example, when the reference pixel determinator 222 receives the left phase image L_PI or the right phase image R_PI from the phase image extractor 210, the reference pixel determinator 222 may identify, as the first reference pixel, the first target pixel included in the left phase image L_PI or the right phase image R_PI and/or at least one of pixels located in the up-down direction from a pixel adjacent to the first target pixel. Also, when the reference pixel determinator 222 receives the top phase image T_PI or the bottom phase image B_PI from the phase image extractor 210, the reference pixel determinator 222 may identify, as the second reference pixel, the second target pixel included in the top phase image T_PI or the bottom phase image B_PI and/or at least one of pixels located in the left-right direction from a pixel adjacent to the second target pixel.

In an embodiment, the noise reducer 224 may receive the identification information L_RP, R_RP, T_RP, and/or B_RP of the target pixel and/or the reference pixel from the reference pixel determinator 222. In an example, the noise reducer 224 may generate the corrected phase image (e.g., L_CPI, R_CPI, T_CPI, and/or B_CPI) based on the identification information (e.g., L_RP, R_RP, T_RP, and/or B_RP) of the target pixel and/or the reference pixel thus received. For example, the noise reducer 224 may generate the corrected left phase image L_CPI by interpolating the pixel data of the target pixel included in the left phase image L_PI based on the identification information (e.g., L_RP) of the target pixel and/or the reference pixel included in the left phase image L_PI. For example, the noise reducer 224 may generate the corrected right phase image R_CPI by performing noise reduction processing on the pixel data of the target pixel included in the right phase image R_PI based on the identification information (e.g., R_RP) of the target pixel and/or the reference pixel included in the right phase image R_PI. For example, the noise reducer 224 may generate the corrected top phase image T_CPI by performing noise reduction processing on the pixel data of the target pixel included in the top phase image T_PI based on the identification information (e.g., T_RP) of the target pixel and/or the reference pixel included in the top phase image T_PI. For example, the noise reducer 224 may generate the corrected bottom phase image B_CPI by performing noise reduction processing on the pixel data of the target pixel included in the bottom phase image B_PI based on the identification information (e.g., B_RP) of the target pixel and/or the reference pixel included in the bottom phase image B_PI.

In some embodiments of the disclosed technology, each of the components (e.g., the reference pixel determinator 222 and the noise reducer 224) of the noise processor 220 is provided only as an example, and one component may perform an operation of any other component. For example, the noise reducer 224 may perform at least one of the operations of the reference pixel determinator 222. In an example, the noise reducer 224 may perform an operation of identifying a reference pixel. For example, the noise reducer 224 may receive the identification information (e.g., L_RP, R_RP, T_RP, and/or B_RP) the target pixel and/or the reference pixel and may identify reference pixels, based on the identification information (e.g., L_RP, R_RP, T_RP, and/or B_RP) the target pixel and/or the reference pixel thus received.

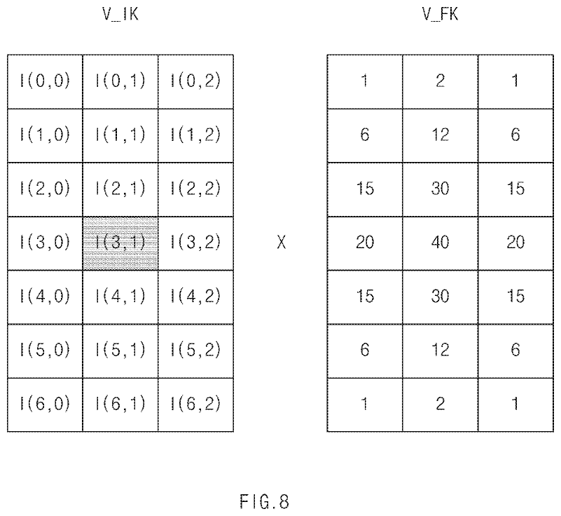

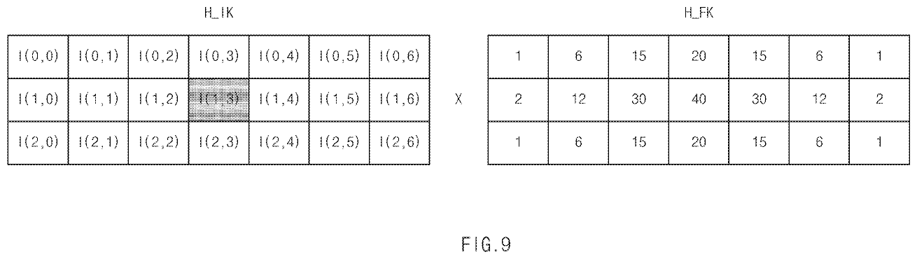

In an embodiment, the noise reducer 224 may perform noise reduction processing on pixel data of a target pixel based on pixel data of a reference pixel. In an example, pixel data of a reference pixel used by the noise reducer 224 to perform noise reduction processing on pixel data of a target pixel, coordinates on the pixel array 110 associated with the reference pixel, the pixel data of the target pixel, and/or coordinate data on the pixel array 110 associated with the target pixel may be included in the identification information (e.g., L_RP, R_RP, T_RP, and/or B_RP) the target pixel and/or the reference pixel. The operations of the reference pixel determinator 222 and/or the noise reducer 224 included in the noise processor 220 will be described in detail with reference to FIGS. 8 and 9.

FIG. 5 is a block diagram illustrating a phase difference calculator based on an embodiment of the disclosed technology.

Referring to FIG. 5, the phase difference calculator 230 may receive the corrected phase image (e.g., L_CPI, R_CPI, T_CPI, and/or B_CPI) from the noise reducer 224. For example, the phase difference calculator 230 may receive the corrected left phase image L_CPI, the corrected right phase image R_CPI, the corrected top phase image T_CPI, and the corrected bottom phase image B_CPI from the noise reducer 224. In an example, the phase difference calculator 230 may generate the phase difference data PDD based on the corrected phase image (e.g., L_CPI, R_CPI, T_CPI, and/or B_CPI).

In an embodiment, the corrected left phase image L_CPI, the corrected right phase image R_CPI, the corrected top phase image T_CPI, and the corrected bottom phase image B_CPI received by the phase difference calculator 230 may be used to generate phase difference image. For example, a left-right phase difference image may be generated based on the corrected left phase image L_CPI and the corrected right phase image R_CPI, and an up-down phase difference image may be generated based on the corrected top phase image T_CPI and the corrected bottom phase image B_CPI.

In an embodiment, the phase difference calculator 230 may calculate a phase difference, based on the phase difference image. In an example, the phase difference calculator 230 may calculate a left-right phase difference or an up-down phase difference, based on a plurality of corrected phase images (e.g., L_CPI, R_CPI, T_CPI, and/or B_CPI). For example, the phase difference calculator 230 may generate the left-right phase difference image based on the corrected left phase image L_CPI and the corrected right phase image R_CPI and may calculate the left-right phase difference from the left-right phase difference image. For example, the phase difference calculator 230 may generate the up-down phase difference image based on the corrected top phase image T_CPI and the corrected bottom phase image B_CPI and may calculate the up-down phase difference from the up-down phase difference image.

In an embodiment, the phase difference calculator 230 may calculate the left-right phase difference, based on a disparity being a difference value of a position corresponding to one spot from among positions of the left phase image and a position corresponding to the one spot of the left phase image from among positions of the right phase image. In an example, the phase difference calculator 230 may calculate the up-down phase difference, based on a disparity being a difference value of a position corresponding to one spot from among positions of the top phase image and a position corresponding to the one spot of the top phase image from among positions of the bottom phase image.

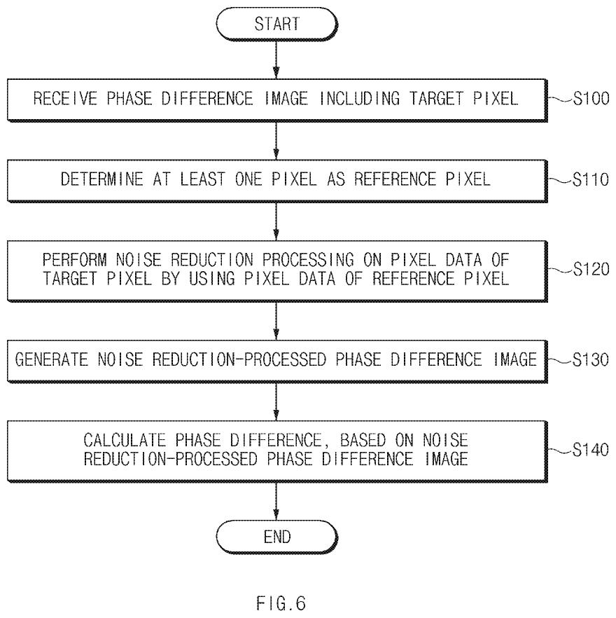

FIG. 6 is a flowchart illustrating an operation of an image processing device based on an embodiment of the disclosed technology.

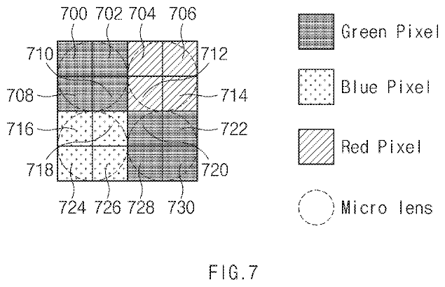

Referring to FIG. 6, the image processing device 200 may receive a phase difference image including a target pixel (S100). For example, the noise processor 220 of the image processing device 200 may receive the phase difference image including the target pixel from the phase image extractor 210. In an example, the phase difference image may correspond to a left-right phase difference image including data of a left phase image and data of a right phase image or an up-down phase difference image including data of a top phase image and data of a bottom phase image. In an example, the image processing device 200 may receive the image data IDATA from the image sensing device 100. In an example, the image data IDATA may correspond to data generated based on the pixel array 110 having a structure where a plurality of pixels share one micro lens. For example, the image data IDATA may include a plurality of phase image data based on pixel data of pixels belonging to the same channel of the micro lens. In the disclosed technology, the same channel may refer to a position of a pixel having the same relative position from the center of the micro lens. Pixels of the same channel will be described in detail with reference to FIG. 7.

In an embodiment, a plurality of pixels may correspond to one micro lens. For example, the plurality of pixels may include first to fourth pixels, the first pixel may be located at the first channel corresponding to the upper left-side of the micro lens, the second pixel may be located at the second channel corresponding to the upper right-side of the micro lens, the third pixel may be located at the third channel corresponding to the lower left-side of the micro lens, and the fourth pixel may be located at the fourth channel corresponding to the lower right-side of the micro lens.

In an embodiment, the image processing device 200 may identify the left phase image based on the pixel data of the pixel corresponding to the first channel of the micro lens and the pixel data of the pixel corresponding to the third channel of the micro lens, from the image data IDATA received from the image sensing device 100. In an example, the image processing device 200 may identify the right phase image based on the pixel data of the pixel corresponding to the second channel and the pixel data of the pixel corresponding to the fourth channel. In an example, the image processing device 200 may identify the top phase image based on the pixel data of the pixel corresponding to the first channel and the pixel data of the pixel corresponding to the second channel. In an example, the image processing device 200 may identify the bottom phase image based on the pixel data of the pixel corresponding to the third channel and the pixel data of the pixel corresponding to the fourth channel.

In an embodiment, the image processing device 200 may identify the left-right phase difference image based on the left phase image and the right phase image. In an example, the image processing device 200 may identify the up-down phase difference image based on the top phase image and the bottom phase image.

In an embodiment, the image processing device 200 may identify the first direction being the phase difference direction of the phase difference image and the second direction being a direction perpendicular to the first direction. In an embodiment, the image processing device 200 may identify, as the first direction, a direction in which a phase difference occurs in the phase difference image and may identify the direction perpendicular to the first direction as the second direction. For example, the image processing device 200 may identify the first direction of the left-right direction based on the left-right phase difference image and may identify the second direction of the up-down direction being a direction perpendicular to the left-right direction. For example, the image processing device 200 may identify the first direction of the up-down direction based on the up-down phase difference image and may identify the second direction of the left-right direction being a direction perpendicular to the up-down direction.

In an embodiment, the image processing device 200 may determine, as the reference pixel, at least one pixel located in the second direction being the direction perpendicular to the phase difference direction from the target pixel included in the phase difference image (S110). In an example, the image processing device 200 may determine, as the reference pixel, the target pixel corresponding to the phase difference image and/or at least one pixel located in the second direction from a pixel adjacent to the target pixel.

In an embodiment, the image processing device 200 may identify reference pixels from a kernel that includes a target pixel and is in a rectangular shape extending in the second direction being the direction perpendicular to the phase difference direction. In an example, in the rectangular kernel, a side in the second direction may be longer than a side in the first direction. For example, the image processing device 200 may set a rectangular kernel for generating the left-right phase difference image in association with the left phase image or the right phase image; in this case, in the rectangular kernel, the target pixel may be centered, a length in the left-right direction may be a 3-pixel pitch, and a length in the up-down direction may be a 7-pixel pitch. Also, the image processing device 200 may determine at least one of the pixels included in the set kernel as a reference pixel. For example, the image processing device 200 may set a rectangular kernel for generating the up-down phase difference image in association with the top phase image or the bottom phase image; in this case, in the rectangular kernel, the target pixel may be centered, a length in the up-down direction may be a 3-pixel pitch, and a length in the left-right direction may be a 7-pixel pitch. Also, the image processing device 200 may determine at least one of the pixels included in the set kernel as a reference pixel.

In an embodiment, the image processing device 200 may perform noise reduction processing on the pixel data of the target pixel by using the pixel data of the reference pixel (S120). In an example, the image processing device 200 may perform noise reduction processing on the pixel data of the target pixel based on the pixel data of the reference pixel determined in operation S110. For example, in association with the left phase image or the right phase image, the image processing device 200 may identify a pixel located in the up-down direction of the target pixel as a reference pixel and may perform noise reduction processing on the target pixel based on the pixel data of the identified reference pixel. For example, in association with the top phase image or the bottom phase image, the image processing device 200 may identify a pixel located in the left-right direction of the target pixel as a reference pixel and may perform noise reduction processing on the target pixel based on the pixel data of the identified reference pixel.

In an embodiment, the image processing device 200 may set a rectangular kernel in association with the left phase image or the right phase image; in this case, in the rectangular kernel, the target pixel may be centered, a length in the left-right direction may be a 5-pixel pitch, and a length in the up-down direction may be a 11-pixel pitch. Also, the image processing device 200 may perform noise reduction processing on the target pixel based on pixel data of at least one of the pixels included in the set kernel. In an example, the image processing device 200 may set a rectangular kernel in association with the top phase image or the bottom phase image; in this case, in the rectangular kernel, the target pixel may be centered, a length in the up-down direction may be a 3-pixel pitch, and a length in the left-right direction may be a 5-pixel pitch. Also, the image processing device 200 may perform noise reduction processing on the target pixel based on pixel data of at least one of the pixels included in the set kernel.

In an embodiment, the image processing device 200 may generate corrected phase difference image (or noise reduction-processed phase difference image) based on the pixel data of the corrected target pixel (or noise reduction-processed target pixel) (S130). In an example, the image processing device 200 may generate the corrected phase difference image by performing noise reduction processing on the target pixel included in the phase difference image. In an example, the image processing device 200 may generate phase difference data, based on the corrected phase difference image. For example, the image processing device 200 may generate phase difference data based on the corrected phase difference image of the target pixel and transfer the generated phase difference data to a timing generator (e.g., 150) or a lens driver (e.g., 144) to adjust the phase difference.

In an embodiment, the image processing device 200 may generate the corrected left-right phase difference image by performing noise reduction processing on the target pixel by using a filter of the up-down direction in association with the left-right phase difference image. For example, the filter of the up-down direction may correspond to a filter using pixel data of pixels included in a kernel whose rectangular shape extends in the up-down direction, with the target pixel centered. According to an example, the image processing device 200 may generate the corrected up-down phase difference image by performing noise reduction processing on the target pixel by using a filter of the left-right direction in association with the up-down phase difference image. For example, the filter of the left-right direction may correspond to a filter using pixel data of pixels included in a kernel whose rectangular shape extends in the left-right direction, with the target pixel centered.

In an embodiment, the image processing device 200 may generate a phase difference based on the corrected phase difference image (S140). In an example, the image processing device 200 may calculate a left-right phase difference based on the disparity of the left-right phase difference image. In an example, the image processing device 200 may calculate an up-down phase difference based on the disparity of the up-down phase difference image. According to an embodiment, the image processing device 200 may generate the phase difference data PDD based on the calculated phase difference and may transfer the generated phase difference data PDD to the timing generator (e.g., 150).

In an embodiment, the image processing device 200 may further improve the performance of phase difference calculation, by performing noise reduction processing on a target pixel by using pixel data of reference pixels corresponding to the second direction being the direction perpendicular to the first direction in association with the phase difference image of the first direction. For example, when noise reduction processing is performed on the target pixel by using the reference pixel corresponding to the left-right direction or the filter corresponding to the left-right direction, a boundary (e.g., an up-down direction pattern) for calculating a phase difference may be blurred, resulting in error in the process of calculating a phase difference. In contrast, when noise reduction processing is performed on the target pixel by using the reference pixel corresponding to the up-down direction or the filter corresponding to the up-down direction, noise reduction processing on the target pixel may be performed in a state where a boundary (e.g., an up-down direction pattern) for calculating a phase difference is not blurred. Accordingly, it may be possible to calculate a phase difference more accurately by using the corrected left-right phase difference image.

FIG. 7 is a diagram illustrating a micro lens and a plurality of pixels corresponding thereto, based on an embodiment of the disclosed technology.

Referring to FIG. 7, the pixel array 110 may include a structure in which pixels (e.g., a first pixel 700, a second pixel 702, a fifth pixel 708, and a sixth pixel 710) arranged in a 2×2 matrix share one micro lens (e.g., a circle marked by a dotted line). In an example, pixels (e.g., a third pixel 704, a fourth pixel 706, a seventh pixel 712, and an eighth pixel 714) arranged in a 2×2 matrix may correspond to one micro lens, and four micro lenses may be arranged in a 2×2 matrix and may correspond to one unit pattern of the pixel array. For example, four micro lenses may be disposed to respectively correspond to the upper left-side, upper right-side, lower left-side, and lower right-side of pixels arranged in a 4×4 matrix. That is, four micro lenses may be disposed in a 2×2 structure.

In an embodiment, one micro lens (e.g., a circle marked by a dotted line) of the pixel array may include a pixel corresponding to a red (e.g., a diagonal pattern) color filter, a pixel corresponding to a green (e.g., a shaded pattern) color filter, or a pixel corresponding to a blue (e.g., a dot pattern) color filter. Also, the four micro lenses may form a Bayer color arrangement. For example, the pixels arranged in the 4×4 matrix included in the pixel array may form one Bayer color arrangement. In this case, pixels that are arranged in a 2×2 matrix, from among the pixels arranged in a 4×4 matrix may share one micro lens. That is, in the pixel array, four micro lenses may be disposed every unit Bayer pattern. The micro lens arrangement based on some embodiments of the disclosed technology is provided only as an example, and the configuration of micro lenses included in the pixel array 110 is not limited to the configuration of FIG. 7. For example, pixels arranged in the pixel array (e.g., 110) in a 3×3 matrix may share one micro lens. For example, in the pixel array, 16 micro lenses may be disposed every unit Bayer pattern.

In an embodiment, a plurality of channels may correspond to one micro lens, and a phase image may be identified based on pixel data of pixels classified for each channel. In an example, in one micro lens, the upper left-side, the upper right-side, the lower left-side, and the lower right-side may correspond to the first channel, the second channel, the third channel, and the fourth channel, respectively. For example, the first pixel 700, the third pixel 704, a ninth pixel 716, and an eleventh pixel 720 may correspond to the first channel. For example, the second pixel 702, the fourth pixel 706, a tenth pixel 718, and a twelfth pixel 722 may correspond to the second channel. For example, the fifth pixel 708, the seventh pixel 712, a thirteenth pixel 724, and a fifteenth pixel 728 may correspond to the third channel. For example, the sixth pixel 710, the eighth pixel 714, a fourteenth pixel 726, and a sixteenth pixel 730 may correspond to the fourth channel.

In an embodiment, the image processing device 200 may identify the left phase image based on pixel data of the pixels corresponding to the first channel and the third channel. For example, the image processing device 200 may identify the left phase image based on pixel data of the first pixel 700, the third pixel 704, the fifth pixel 708, the seventh pixel 712, the ninth pixel 716, the eleventh pixel 720, the thirteenth pixel 724, and the fifteenth pixel 728. In an example, the image processing device 200 may identify the right phase image based on pixel data of the pixels corresponding to the second channel and the fourth channel. For example, the image processing device 200 may identify the right phase image based on pixel data of the second pixel 702, the fourth pixel 706, the sixth pixel 710, the eighth pixel 714, the tenth pixel 718, the twelfth pixel 722, the fourteenth pixel 726, and the sixteenth pixel 730.

In an embodiment, the image processing device 200 may identify the top phase image based on pixel data of the pixels corresponding to the first channel and the second channel. For example, the image processing device 200 may identify the top phase image based on pixel data of the first pixel 700, the second pixel 702, the third pixel 704, the fourth pixel 706, the ninth pixel 716, the tenth pixel 718, the eleventh pixel 720, and the twelfth pixel 722. In an example, the image processing device 200 may identify the bottom phase image based on pixel data of the pixels corresponding to the third channel and the fourth channel. For example, the image processing device 200 may identify the bottom phase image based on pixel data of the fifth pixel 708, the sixth pixel 710, the seventh pixel 712, the eighth pixel 714, the thirteenth pixel 724, the fourteenth pixel 726, the fifteenth pixel 728, and the sixteenth pixel 730.

FIG. 8 is a diagram illustrating a target kernel and a filter kernel used to perform noise reduction processing on a left-right phase image, based on an embodiment of the disclosed technology.

Referring to FIG. 8, to perform noise reduction processing on a target pixel included in a phase image whose phase difference direction is the first direction, the image processing device 200 may use a target kernel or a filter kernel that extends in the second direction, which is perpendicular to the first direction. In an example, to perform noise reduction processing on a target pixel included in the left phase image or the right phase image, the image processing device 200 may use a target kernel V_IK and/or a filter kernel V_FK that includes the target pixel and extends in the up-down direction.

In an embodiment, to perform noise reduction processing on a target pixel included in the left phase image or the right phase image, the image processing device 200 may set the target kernel V_IK extending in the up-down direction, with the target pixel centered, and may set the filter kernel V_FK corresponding to the target kernel V_IK. In an example, the image processing device 200 may perform noise reduction processing on the target pixel based on a value obtained by multiplying weight data of the filter kernel V_FK and the pixel data included in the target kernel V_IK together. In an example, as a distance from the target pixel decreases, the weight data may have a higher value.

In an embodiment, when the image processing device 200 performs noise reduction processing on pixel data I(3,1) of the target pixel by using the target kernel V_IK and the filter kernel V_FK, the pixel data of the target pixel may be determined by Equation 1 below. In Equation 1 below, j may correspond to an up-down direction coordinate, i may correspond to a left-right direction coordinate, I(j,i) may correspond to pixel data of the target kernel V_IK, and F(j,i) may correspond to weight data of the filter kernel V_FK.

$$I ( 3 , 1 ) = \frac{{\sum }_{j = 0}^{6} {\sum }_{i = 0}^{2} F ( j , i ) I ( j , i )}{{\sum }_{j = 0}^{6} {\sum }_{i = 0}^{2} F ( j , i )} \qquad [ Equation 1 ]$$

In an embodiment, the image processing device 200 may perform noise reduction processing on the target pixel by using pixels, whose pixel data difference with the target pixel is smaller than or equal to a threshold value, from among the pixels included in the target kernel V_IK. In an example, the threshold value may correspond to a value that is set and stored in advance. In an example, the threshold value may correspond to a pixel data average value of pixels included in one pixel group.

In an embodiment, when the image processing device 200 performs noise reduction processing on the target pixel by using the target kernel V_IK and the pixels whose pixel data difference with the target pixel is smaller than or equal to the threshold value, the pixel data of the target pixel may be determined by Equation 2 and Equation 3 below. In Equation 2 and Equation 3 below, j may correspond to an up-down direction coordinate of a kernel, i may correspond to a left-right direction coordinate of a kernel, I(j,i) may correspond to pixel data of the target kernel V_IK, T may correspond to a threshold value, and W(j,i) may correspond to threshold data.

$$W ( j , i ) = \{ \begin{matrix}0 & \vert I ( j , i ) - I ( 3 , 1 ) \vert > T \\ 1 & \vert I ( j , i ) - I ( 3 , 1 ) \vert \leq T\end{matrix} \qquad [ Equation 2 ]$$

$$I ( 3 , 1 ) = \frac{{\sum }_{j = 0}^{6} {\sum }_{i = 0}^{2} W ( j , i ) I ( j , i )}{{\sum }_{j = 0}^{6} {\sum }_{i = 0}^{2} W ( j , i )} \qquad [ Equation 3 ]$$

FIG. 9 is a diagram illustrating a target kernel and a filter kernel used to perform noise reduction processing on an up-down phase image, based on an embodiment of the disclosed technology.

Referring to FIG. 9, to perform noise reduction processing on a target pixel included in a phase image whose phase difference direction is the second direction, the image processing device 200 may use a target kernel or a filter kernel that extends in the first direction being a direction perpendicular to the second direction. In an example, to perform noise reduction processing on a target pixel included in the top phase image or the bottom phase image, the image processing device 200 may use a target kernel H_IK or a filter kernel H_FK that includes the target pixel and extends in the left-right direction.

In an embodiment, to perform noise reduction processing on a target pixel included in the top phase image or the bottom phase image, the image processing device 200 may set the target kernel H_IK extending in the left-right direction, with the target pixel centered, and may set the filter kernel H_FK corresponding to the target kernel H_IK. In an example, the image processing device 200 may perform noise reduction processing on the target pixel based on a value obtained by multiplying weight data of the filter kernel H_FK and the pixel data included in the target kernel H_IK together. In an example, as a distance from the target pixel decreases, the weight data may have a higher value.

In an embodiment, when the image processing device 200 performs noise reduction processing on the pixel data I(1,3) of the target pixel by using the target kernel H_IK and the filter kernel H_FK, the pixel data of the target pixel may be determined by Equation 4 below. In Equation 4 below, j may correspond to an up-down direction coordinate, i may correspond to a left-right direction coordinate of a kernel, I(j,i) may correspond to pixel data of the target kernel H_IK, and F(j,i) may correspond to weight data of the filter kernel H_FK.

$$I ( 1 , 3 ) = \frac{{\sum }_{j = 0}^{2} {\sum }_{i = 0}^{6} I ( j , i ) F ( j , i )}{{\sum }_{j = 0}^{2} {\sum }_{i = 0}^{6} F ( j , i )} \qquad [ Equation 4 ]$$

In an embodiment, the image processing device 200 may perform noise reduction processing on the target pixel by using pixels, whose pixel data difference with the target pixel is smaller than or equal to a threshold value, from among the pixels included in the target kernel H_IK. In an example, the threshold value may correspond to a value that is set and stored in advance. In an example, the threshold value may correspond to a pixel data average value of pixels included in one pixel group.

In an embodiment, when the image processing device 200 performs noise reduction processing on the target pixel by using the target kernel H_IK and the pixels whose pixel data difference with the target pixel is smaller than or equal to the threshold value, the pixel data of the target pixel may be determined by Equation 5 and Equation 6 below. In Equation 5 and Equation 6 below, j may correspond to an up-down direction coordinate of a kernel, i may correspond to a left-right direction coordinate of a kernel, I(j,i) may correspond to pixel data of the target kernel H_IK, T may correspond to a threshold value, and W(j,i) may correspond to threshold data.

$$W ( j , i ) = \{ \begin{matrix}0 & \vert I ( j , i ) - I ( 1 , 3 ) \vert > T \\ 1 & \vert I ( j , i ) - I ( 1 , 3 ) \vert \leq T\end{matrix} \qquad [ Equation 5 ]$$

$$I ( 1 , 3 ) = \frac{{\sum }_{j = 0}^{2} {\sum }_{i = 0}^{6} W ( j , i ) I ( j , i )}{{\sum }_{j = 0}^{2} {\sum }_{i = 0}^{6} W ( j , i )} \qquad [ Equation 6 ]$$

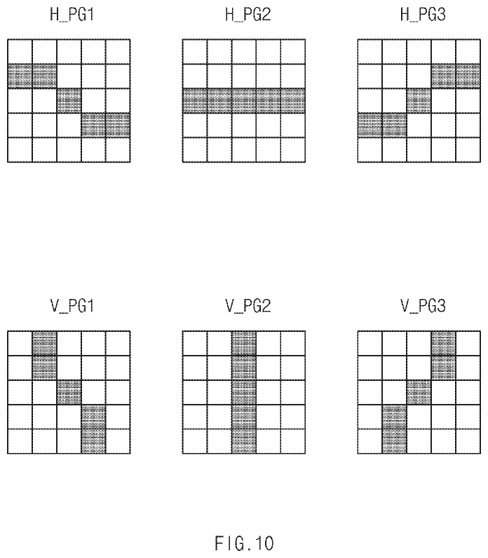

FIG. 10 is a diagram illustrating pixel groups used to perform noise reduction processing on a phase image, based on an embodiment of the disclosed technology.

Referring to FIG. 10, the image processing device 200 may set pixel groups for performing noise reduction processing on a target pixel included in a phase image (e.g., L_PI, R_PI, T_PI, and/or B_PI). In an example, the pixel group may correspond to a pixel group, in which pixels are located to correspond to one direction, in a target kernel of a 5×5 array where the target pixel is centered. For example, in association with a pixel group (e.g., shaded pixels of pixel groups H_PG1, H_PG2, and H_PG3) corresponding to the left-right direction, noise reduction processing on the target pixel may be performed by using pixel data of pixels corresponding to the left-right direction in the kernel of the 5×5 array where the target pixel is centered.

In an embodiment, the image processing device 200 may select at least one phase image among the pixel groups, based on a phase difference direction of the phase image. Also, the image processing device 200 may perform noise reduction processing on the target pixel based on pixel data of pixels included in the selected pixel group. In an example, the image processing device 200 may select a pixel group corresponding to a direction perpendicular to the phase difference direction of the phase image.

In an embodiment, to perform noise reduction processing on a target pixel of the top phase image or the bottom phase image, the image processing device 200 may select one of the left-right direction pixel groups (e.g., H_PG1, H_PG2, and H_PG3). For example, in association with the top phase image, the image processing device 200 may determine, as pixel data of the target pixel, an average value of pixel data of a first left-right direction pixel group (shaded pixels of the pixel group H_PG1). For example, in association with the bottom phase image, the image processing device 200 may determine, as pixel data of the target pixel, an average value of pixel data of a second left-right direction pixel group (shaded pixels of the pixel group H_PG2).

In an embodiment, the image processing device 200 may set pixel groups for performing noise reduction processing on a target pixel included in a phase image. In an example, the pixel group may correspond to a pixel group, in which pixels are located to correspond to one direction, in a target kernel of a 5×5 array where the target pixel is centered. For example, in association with a pixel group (e.g., shaded pixels of pixel groups V_PG1, V_PG2, and V_PG3) corresponding to the up-down direction, noise reduction processing on the target pixel may be performed by using pixel data of pixels corresponding to the up-down direction in the kernel of the 5×5 array where the target pixel is centered.

In an embodiment, the image processing device 200 may select at least one pixel group among the pixel groups, based on a phase difference direction of the phase image. Also, the image processing device 200 may perform noise reduction processing on the target pixel based on pixel data of pixels included in the selected pixel group. In an example, the image processing device 200 may select a pixel group corresponding to a direction perpendicular to the phase difference direction of the phase image.

In an embodiment, to perform noise reduction processing on a target pixel of the left phase image or the right phase image, the image processing device 200 may select one of the up-down direction pixel groups (e.g., V_PG1, V_PG2, and V_PG3). For example, in association with the left phase image, the image processing device 200 may determine, as pixel data of the target pixel, an average value of pixel data of a third up-down direction pixel group (shaded pixels of the pixel group V_PG3). For example, in association with the right phase image, the image processing device 200 may perform noise reduction processing on the target pixel by using pixel data, whose difference with the pixel data of the target pixel is the threshold value or less, from among pixel data of the first up-down direction pixel group (shaded pixels of the pixel group V_PG1).

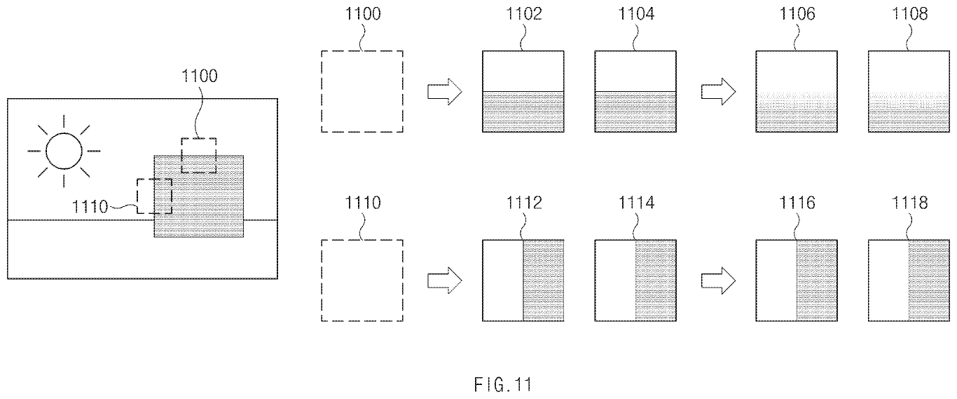

FIG. 11 is a diagram illustrating a left-right phase image before noise reduction processing and a left-right phase image after noise reduction processing, based on an embodiment of the disclosed technology.

Referring to FIG. 11, in association with a first region 1100 of an image, the image processing device 200 may identify a first left phase image 1102 before noise reduction processing and a first right phase image 1104 before noise reduction processing. In an example, the image processing device 200 may generate a first left phase image 1106 after noise reduction processing, by performing noise reduction processing on a target pixel included in the first left phase image 1102 before noise reduction processing. In an example, the image processing device 200 may generate a first right phase image 1108 after noise reduction processing, by performing noise reduction processing on a target pixel included in the first right phase image 1104 before noise reduction processing.

In an embodiment, as the noise of the left phase image or right phase image for generating the left-right phase difference image increases, the accuracy of an operation of calculating the disparity of the left-right phase difference image may become lower. For example, when the noise of the left phase image or the right phase image increases, an error included in a left-right phase difference calculated by the image processing device 200 may become greater.

In an embodiment, in association with the left phase image and/or the right phase image, when the image processing device 200 performs noise reduction processing on a target pixel by using pixel data of pixels corresponding to the left-right direction (e.g., the first direction) of the target pixel, the up-down direction boundary for identifying the left-right phase difference may be blurred, causing a decrease in accuracy of the operation of calculating the disparity of the left-right phase difference image. In contrast, in association with the left phase image and/or the right phase image, when the image processing device 200 performs noise reduction processing on a target pixel by using pixel data of pixels corresponding to the up-down direction (e.g., the second direction) of the target pixel, the left-right direction boundary (e.g., the first left phase image 1106 after noise reduction processing and the first right phase image 1108 after noise reduction processing) may be blurred, but the up-down direction boundary for identifying the left-right phase difference may remain unblurred.

To sum up, in association with the left phase image and/or the right phase image, when the image processing device 200 performs noise reduction processing on the target pixel by using the pixel data of the pixels corresponding to the up-down direction of the target pixel, because the up-down direction boundary is not blurred due to noise reduction processing, the performance of the operation of calculating the left-right phase difference may be improved.

In an embodiment, in association with a second region 1110 of the image, the image processing device 200 may identify a second left phase image 1112 before noise reduction processing and a second right phase image 1114 before noise reduction processing. In an example, a target pixel may be included in each of the second left phase image 1112 before noise reduction processing and the second right phase image 1114 before noise reduction processing. In an example, the image processing device 200 may generate a second left phase image 1116 after noise reduction processing, by performing noise reduction processing on the target pixel included in the second left phase image 1112 before noise reduction processing. In an example, the image processing device 200 may generate a second right phase image 1118 after noise reduction processing, by performing noise reduction processing on the target pixel included in the second right phase image 1114 before noise reduction processing.

In an embodiment, as the noise of the left phase image or the right phase image for generating the left-right phase difference image increases, the accuracy of an operation of calculating the disparity of the left-right phase difference image may become lower. For example, when the noise of the left phase image or the right phase image increases, an error included in a left-right phase difference calculated by the image processing device 200 may become greater.

In an embodiment, in association with the left phase image and/or the right phase image, when the image processing device 200 performs noise reduction processing on a target pixel by using pixel data of pixels corresponding to the left-right direction (e.g., the first direction) of the target pixel, the up-down direction boundary for identifying the left-right phase difference may be blurred, causing a decrease in accuracy of the operation of calculating the disparity of the left-right phase difference image. In contrast, in association with the left phase image and/or the right phase image, when the image processing device 200 performs noise reduction processing on the target pixel by using pixel data of pixels corresponding to the up-down direction (e.g., the second direction) of the target pixel, the left-right direction boundary may be blurred, but the up-down direction boundary (e.g., the boundary of the second left phase image 1116 after noise reduction processing and the second right phase image 1118 after noise reduction processing) for identifying the left-right phase difference may remain unblurred.

To sum up, to generate the left-right phase difference image based on the left phase image and/performs or the right phase image, the image processing device 200 may perform noise reduction processing on the target pixel by using the pixel data of the pixels corresponding to the up-down direction of the target pixel, and thus, the up-down direction boundary may remain unblurred due to noise reduction processing. Accordingly, the performance of the operation of calculating the left-right phase difference is improved.

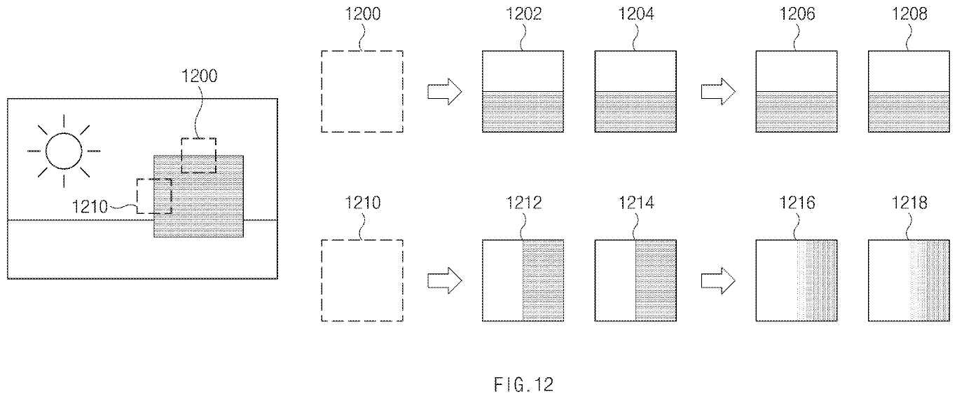

FIG. 12 is a diagram illustrating an up-down phase image before noise reduction processing and an up-down phase image after noise reduction processing, based on an embodiment of the disclosed technology.

Referring to FIG. 12, in association with a first region 1200 of an image, the image processing device 200 may identify a first top phase image 1202 before noise reduction processing and a first bottom phase image 1204 before noise reduction processing. In an example, a target pixel may be included in each of the first top phase image 1202 before noise reduction processing and the first bottom phase image 1204 before noise reduction processing. In an example, the image processing device 200 may generate a first top phase image 1206 after noise reduction processing, by performing noise reduction processing on the target pixel included in the first top phase image 1202 before noise reduction processing. In an example, the image processing device 200 may generate a first bottom phase image 1208 after noise reduction processing, by performing noise reduction processing on the target pixel included in the first bottom phase image 1204 before noise reduction processing.

In an embodiment, as the noise of the top phase image or the bottom phase image for generating the up-down phase difference image increases, the accuracy of an operation of calculating the disparity of the up-down phase difference image may become lower. For example, when a defective pixel is included in the top phase image or the bottom phase image, an error included in an up-down phase difference calculated by the image processing device 200 may become greater.

In an embodiment, in association with the top phase image and/or the bottom phase image, when the image processing device 200 performs noise reduction processing on a target pixel by using pixel data of pixels corresponding to the up-down direction (e.g., the second direction) of the target pixel, the left-right direction boundary for identifying the up-down phase difference may become blurred, causing a decrease in accuracy of the operation of calculating the disparity of the up-down phase difference image. In contrast, in association with the top phase image and/or the bottom phase image, when the image processing device 200 performs noise reduction processing on the target pixel by using pixel data of pixels corresponding to the left-right direction (e.g., the first direction) of the target pixel, the left-right direction boundary may become blurred, but the up-down direction boundary (e.g., the boundary of the first top phase image 1206 after noise reduction processing and the first bottom phase image 1208 after noise reduction processing) for identifying the left-right phase difference may remain unblurred.

To sum up, in association with the top phase image and/or the bottom phase image, when the image processing device 200 performs noise reduction processing on the target pixel by using the pixel data of the pixels corresponding to the left-right direction of the target pixel, because the left-right direction boundary is not blurred due to noise reduction processing, the performance of the operation of calculating the up-down phase difference may be improved.

In an embodiment, in association with a second region 1210 of the image, the image processing device 200 may identify a second top phase image 1212 before noise reduction processing and a second bottom phase image 1214 before noise reduction processing. In an example, a target pixel may be included in each of the second top phase image 1212 before noise reduction processing and the second bottom phase image 1214 before noise reduction processing. In an example, the image processing device 200 may generate a second top phase image 1216 after noise reduction processing, by performing noise reduction processing on the target pixel included in the second top phase image 1212 before noise reduction processing. In an example, the image processing device 200 may generate a second bottom phase image 1218 after noise reduction processing, by performing noise reduction processing on the target pixel included in the second bottom phase image 1214 before noise reduction processing.

In an embodiment, as the noise of the top phase image or the bottom phase image for generating the up-down phase difference image increases, the accuracy of an operation of calculating the disparity of the up-down phase difference image may become lower. For example, when the noise of the top phase image or the bottom phase image increases, an error included in an up-down phase difference which the image processing device 200 calculates may become greater.

In an embodiment, in association with the top phase image and/or the bottom phase image, when the image processing device 200 performs noise reduction processing on a target pixel by using pixel data of pixels corresponding to the up-down direction (e.g., the second direction) of the target pixel, the left-right direction boundary for identifying the up-down phase difference may be blurred, causing a decrease in accuracy of the operation of calculating the disparity of the up-down phase difference image. In contrast, in association with the top phase image and/or the bottom phase image, when the image processing device 200 performs noise reduction processing on a target pixel by using pixel data of pixels corresponding to the left-right direction (e.g., the first direction) of the target pixel, the up-down direction boundary (e.g., the boundary of the second top phase image 1216 after noise reduction processing and the boundary of the second bottom phase image 1218 after noise reduction processing) may be blurred, but the left-right direction boundary for identifying the up-down direction phase difference may remain unblurred.

To sum up, in association with the top phase image and/or the bottom phase image, when the image processing device 200 performs noise reduction processing on the target pixel by using the pixel data of the pixels corresponding to the left-right direction of the target pixel, because the left-right direction boundary is not blurred due to noise reduction processing, the performance of the operation of calculating the up-down phase difference may be improved.

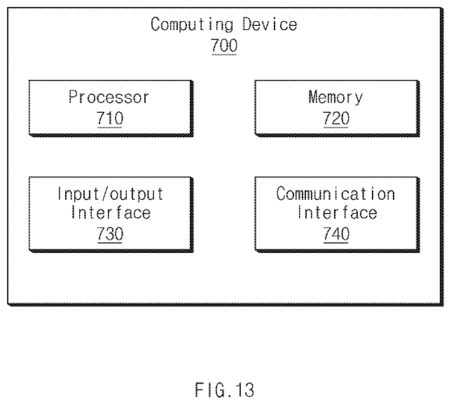

FIG. 13 is a block diagram illustrating an example of a computing device corresponding to a processor of FIG. 1.

Referring to FIG. 13, a computing device 700 may show an embodiment of a hardware configuration for performing the operation of the image processing device 200 of FIG. 1.

The computing device 700 may be mounted on a chip independent of a chip on which an image sensing device is mounted. In an embodiment, the chip on which the image sensing device is mounted and the chip on which the computing device 700 is mounted may be implemented with a single package, for example, a multi-chip package (MCP), but the scope of the disclosed technology is not limited thereto.

Also, internal components and arrangements of the computing device 700 and the image sensing device may vary depending on embodiments. For example, at least some components of the image sensing device may be included in the computing device 700. Alternatively, at least some components of the computing device 700 may be included in the image sensing device. In this case, the at least some components of the computing device 700 may be together included in the chip on which the image sensing device is mounted.

The computing device 700 may include a processor 710, a memory 720, an input/output interface 730, and a communication interface 740.

The processor 710 may process data and/or an instruction necessary to perform the operations of the components 210, 220 and 230 of the image processing device 200 described with reference to FIG. 1. That is, the processor 710 may refer to the image processing device 200 itself, but the scope of the disclosed technology is not limited thereto. In some embodiments, the image signal processing method disclosed in this patent document may be executed by the image processing device 200. In one example, the image processing device 200 is within the image sensing device 100. In another example, the image processing device 200 is outside the image sensing device 100. In some embodiments, the image signal processing method disclosed in this patent document may be executed by the processor 710 based on image data captured by an image sensing device. The processor 710 may perform reference pixel determination and noise reduction.

The memory 720 may store data and/or an instruction necessary to perform the operations of the components 210, 220, and 230 of the image processing device 200 and may be accessed by the processor 710. For example, the memory 720 may be implemented with a volatile memory (e.g., a DRAM (Dynamic Random Access Memory) or an SRAM (Static Random Access Memory) or a nonvolatile memory (e.g., a PROM (Programmable Read Only Memory), an EPROM (Erasable PROM), an EEPROM (Electrically Erasable PROM), or a flash memory).

That is, as a computer program for performing the operation of the image processing device 200 disclosed in the specification is recorded at the memory 720 and is executed and processed by the processor 710, the operations of the image processing device 200 may be implemented.

The input/output interface 730 may provide an interface which connects the processor 710 with an external input device (e.g., a keyboard, a mouse, or a touch panel) and/or an external output device (e.g., a display) such that data are transmitted/received.

The communication interface 740 is a component capable of exchanging various kinds of data with an external device (e.g., an application processor or an external memory) may be a device capable of supporting wired or wireless communication.

In some embodiments of the disclosed technology, even when an error occurs between a phase difference detected from a pixel and a lens position, the accuracy for phase difference detection may be improved by considering a characteristic of a pixel using a micro lens.

Additionally, various effects that are directly or indirectly understood from the specification may be provided.

Although a number of illustrative embodiments have been described, it should be understood that modifications and enhancements to the disclosed embodiments and other embodiments can be devised based on what is described and/or illustrated in this patent document.

What is claimed is:

1. An image processing device comprising:
a reference pixel determinator configured to: receive first phase image data of an image captured by an imaging sensing device, the first phase image data including pixel data of a first target pixel within the image sensing device; and determine, as a first reference pixel for the first target pixel, at least one pixel that is located in a direction perpendicular to a phase difference direction of the first phase image data, with respect to the first target pixel; and
a noise reducer configured to receive pixel data of the first reference pixel and the pixel data of the first target pixel from the reference pixel determinator and configured to perform noise reduction processing on the pixel data of the first target pixel by using the pixel data of the first reference pixel.

2. The image processing device of claim 1, wherein the first phase image data are generated based on pixel data of a plurality of pixels configured to share a micro lens.

3. The image processing device of claim 2, wherein the plurality of pixels include a first pixel, a second pixel, a third pixel, and a fourth pixel,
wherein the first pixel is located on an upper-left portion of the micro lens,
wherein the second pixel is located on an upper-right portion of the micro lens,
wherein the third pixel is located on a lower-left portion of the micro lens, and
wherein the fourth pixel is located on a lower-right portion of the micro lens.

4. The image processing device of claim 3, wherein the phase difference direction of the first phase image is a left-right direction based on an arrangement of pixels under the micro lens,
wherein the first phase image data include: left phase image data generated based on pixel data of the first pixel and pixel data of the third pixel; or right phase image data generated based on pixel data of the second pixel and pixel data of the fourth pixel.

5. The image processing device of claim 1, wherein the reference pixel determinator is configured to:
set a first kernel in which a side in the direction perpendicular to the phase difference direction of the first phase image data is longer than a side in the phase difference direction of the first phase image data; and
determine at least one pixel included in the first kernel as the first reference pixel, and
wherein the first target pixel is located at a center of the first kernel.

6. The image processing device of claim 5, wherein the reference pixel determinator is configured to apply a higher weight to the pixel data of the first reference pixel as a distance between the first reference pixel and the first target pixel decreases.

7. The image processing device of claim 5, wherein the reference pixel determinator is configured to:
determine, as the first reference pixel, at least one pixel included in the first kernel that has a pixel data difference value with the first target pixel smaller than or equal to a threshold value.

8. The image processing device of claim 1, further comprising:
a phase difference calculator configured to calculate a phase difference based on first phase image data obtained by performing noise reduction processing on the pixel data of the first target pixel.

9. The image processing device of claim 1, wherein the reference pixel determinator is configured to:
receive second phase image data including pixel data of a second target pixel; and
determine, as a second reference pixel for the second target pixel, at least one pixel that is located in a direction perpendicular to a phase difference direction of a second phase image, with respect to the second target pixel, and
wherein the noise reducer is configured to perform noise reduction processing on the pixel data of the second target pixel by using pixel data of the second reference pixel.

10. The image processing device of claim 9, wherein the reference pixel determinator is configured to:
set a second kernel in which a side in a direction perpendicular to the phase difference direction of the second phase image is longer than a side in the phase difference direction of the second phase image; and
determine at least one pixel included in the second kernel as the second reference pixel, and
wherein the second target pixel is located at a center of the second kernel.

11. The image processing device of claim 9, wherein the phase difference direction of the second phase image is perpendicular to the phase difference direction of the first phase image.

12. An image signal processing method comprising:
receiving, by an image processing device, a phase difference image in a first direction from an image sensing device that captures an image;
determining, by the image processing device, as a reference pixel, at least one pixel that is located in a second direction perpendicular to the first direction from a target pixel included in the phase difference image; and
performing, by the image processing device, noise reduction processing on pixel data of the target pixel by using pixel data of the reference pixel.

13. The image signal processing method of claim 12, wherein the phase difference image is a left-right phase difference image or an up-down phase difference image.

14. The image signal processing method of claim 12, further comprising:
generating, by the image processing device, a noise reduction-processed phase difference image based on the pixel data of the target pixel experiencing the noise reduction processing.

15. The image signal processing method of claim 14, further comprising:
calculating, by the image processing device, a phase difference based on the noise reduction-processed phase difference image.

16. The image signal processing method of claim 12, wherein the determining of the at least one pixel as the reference pixel includes:
setting a kernel in which a side in the second direction is longer than a side in the first direction; and
determining at least one pixel included in the kernel as the reference pixel, and
wherein the target pixel is located at a center of the kernel.

17. The image signal processing method of claim 12, wherein the determining of the at least one pixel as the reference pixel includes:
determining at least one pixel located in an up-down direction from the target pixel as the reference pixel in response to determining that the first direction is a left-right direction; and
determining at least one pixel located in the left-right direction from the target pixel as the reference pixel in response to determining that the first direction is the up-down direction.

18. The image signal processing method of claim 12, wherein the determining of the at least one pixel as the reference pixel includes:
determining, as the reference pixel, at least one pixel located in the second direction that has a pixel data difference value with the target pixel smaller than or equal to a threshold value.

19. An image processing device comprising:
a reference pixel determinator configured to: receive phase image data including pixel data of a target pixel; set a plurality of pixel groups, each including the target pixel and at least one pixel located in a direction perpendicular to a phase difference direction of a phase image, with respect to a pixel adjacent to the target pixel; select one of the plurality of pixel groups; and determine at least one pixel included in the selected pixel group as a reference pixel; and
a noise reducer configured to perform noise reduction processing on the pixel data of the target pixel by using pixel data of the reference pixel.

20. The image processing device of claim 19, further comprising:
a phase difference calculator configured to calculate a phase difference in the phase difference direction by using phase image data obtained by performing noise reduction processing on the pixel data of the target pixel.
